(19) United States
(12) Patent Application Publication
(10) Pub. No.: US 2008/0098066 A1
(43) Pub. Date: Apr. 24, 2008

(54) SYSTEM AND METHOD FOR IMPLEMENTING LATEST EDITION NOTIFICATION FOR MESSAGES OF DATA PROCESSING SYSTEMS

(76) Inventors: Jeffry R. Mausolf, Austin, TX (US); Kimberly A. Stephens, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/551,296

(22) Filed: Oct. 20, 2006

(51) Int. Cl. G06F 15/16

(52) U.S. Cl. 709/204

(57) ABSTRACT

A computer-implementable method, system, and computer-readable medium for implementing latest edition notification for messages on a data processing system. An e-mail client receives from a server a first message in a conversation thread, wherein the conversation thread includes a collection of messages. In response to receiving a command from a user to open the first message, the server determines if the conversation thread includes a second message that was created after the first message. In response to determining the conversation thread includes the second message, the server opens the second message instead of the first message.

### BACKGROUND OF THE INVENTION

1. Technical Field

The present invention relates in general to the field of data processing systems. More particularly, the present invention relates to the field of electronic messaging between networked data processing systems. Still more particularly, the present invention relates to a system and method for implementing latest edition notification for messages on data processing systems.

2. Description of the Related Art

Some convenient features of electronic mail (e-mail) include forwarding notes to another party or replying to a note while including the previous message text in the reply. These features preserve the history on the subject within a single e-mail and are preferable to trying to manually locate multiple individual notes related to a subject and reading each individual note in order to understand the sequence of events that resulted in the most recent e-mail.

However, the use of forwarding and prior message incorporation includes some limitations. For example, when a user is replying to one of many e-mails in an e-mail client, another e-mail may include the entire contents of the current e-mail plus a more recent comment that was added when the current e-mail was forwarded or responded to using the “reply with history” feature. Therefore, there is a need for a system and method for addressing the limitations of the prior art.

### SUMMARY OF THE INVENTION

The present invention includes a computer-implementable method, system, and computer-readable medium for implementing latest edition notification for messages on a data processing system. An e-mail client receives from a server a first message in a conversation thread, wherein the conversation thread includes a collection of messages. In response to receiving a command from a user to open the first message, the server determines if the conversation thread includes a second message that was created after the first message. In response to determining the conversation thread includes the second message, the server opens the second message instead of the first message.

The above, as well as additional purposes, features, and advantages of the present invention will become apparent in the following detailed written description.

### BRIEF DESCRIPTION OF THE FIGURES

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying figures, wherein:

FIG. 1A is a block diagram of an exemplary network in which a preferred embodiment of the present invention may be implemented;

FIG. 1B is a block diagram of an exemplary data processing system in which a preferred embodiment of the present invention may be implemented;

FIG. 2 is a block diagram depicting exemplary contents of a system memory as illustrated in FIG. 1B; and

FIGS. 3A-3D are high-level flowcharts illustrating an exemplary method for implementing latest edition notification for messages on a data processing system.

### DETAILED DESCRIPTION OF A PREFERRED EMBODIMENT

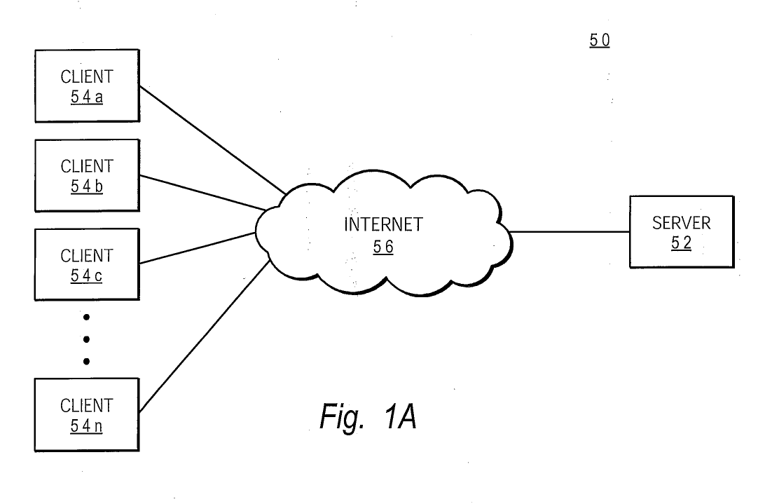

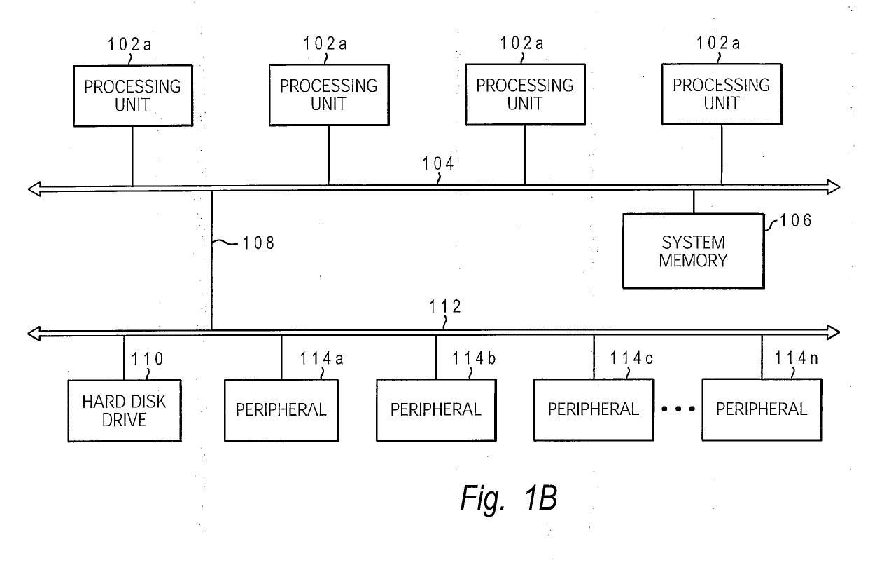

Referring now to the figures, and in particular, referring to FIG. 1A, there is illustrated an exemplary network 50 in which a preferred embodiment of the present invention may be implemented. As depicted, network 50 includes a server 52 coupled to clients 54a-54n via Internet 56. Those with skill in the art will appreciate that Internet 56 may also be implemented as a wide-area or a local-area network. Clients 54a-54n are connected to server 52 to upload to and download information from server 52. To enable a client (e.g., client 54a) to connect to server 52, the client must log-on to server 52 via a login protocol that identifies and verifies the identity of the client. In an embodiment of the present invention, a client 54a may send an electronic mail (e-mail) message addressed to client 54b to server 52. Later, client 54b logs on to server 52 to retrieve the e-mail message sent by client 54a.

With reference to FIG. 1B, there is illustrated an exemplary data processing system 100, which may be utilized to implement server 52 and clients 54a-54n of network 50 as shown in FIG. 1. As illustrated, data processing system 100 includes a collections of processing units 102a-n, which are coupled to system memory 106 via a system interconnect 104. System interconnect 104 is coupled to peripheral interconnect 112 via mezzanine interconnect 108. Those with skill in the art will appreciate that peripheral interconnect 112 may be implemented by any type of interconnect including, but not limited to: peripheral component interconnect (PCI) bus, advanced graphics port (AGP), small computer system interface (SCSI), etc. Coupled to peripheral interconnect 112 is a hard disk drive 110 for mass storage and a collection of peripherals 114a-114n, which may include, but are not limited to: optical drives, other hard disk drives, printers, input devices, etc.

Those with skill in the art will appreciate that data processing system 100 can include many additional components not specifically illustrated in FIG. 1B. Because such additional components are not necessary for an understanding of the present invention, they are not illustrated in FIG. 1B or discussed further herein. It should be understood, however, that the enhancements to data processing system 100 for enhancing environment variable and process option invocation provided by the present invention are applicable to data processing systems of any system architecture and are in no way limited to the generalized multi-processor architecture or symmetric multi-processing (SMP) architecture illustrated in FIG. 1B.

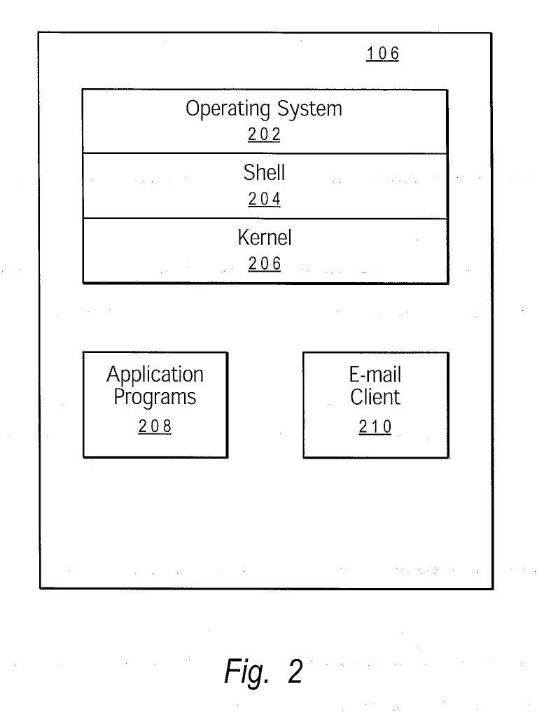

FIG. 2 is a block diagram illustrating exemplary contents of system memory 106 of data processing system 100, according to a preferred embodiment of the present invention. As shown, system memory 106 includes operating system 202, which further includes shell 204 for providing transparent user access to resources such as application programs 208. Generally, shell 204 is a program that provides an interpreter and an interface between the user and the operating system. More specifically, shell 204 executes commands that are entered into a command line user interface or a file. Thus, shell 204 (as it is called in UNIX®), also called a command processor in Windows®, is generally the highest level of the operating system software a-hierarchy and serves as a command interpreter. The shell provides a system prompt, interprets commands entered by keyboard, mouse, or other user input media, and sends the interpreted command(s) to the appropriate lower levels of the operating system (e.g., kernel 206) for processing. Note that while shell 204 is a text-based, line-oriented user interface, the present invention will support other user interface modes, such as graphical, voice, gestural, etc. equally well.

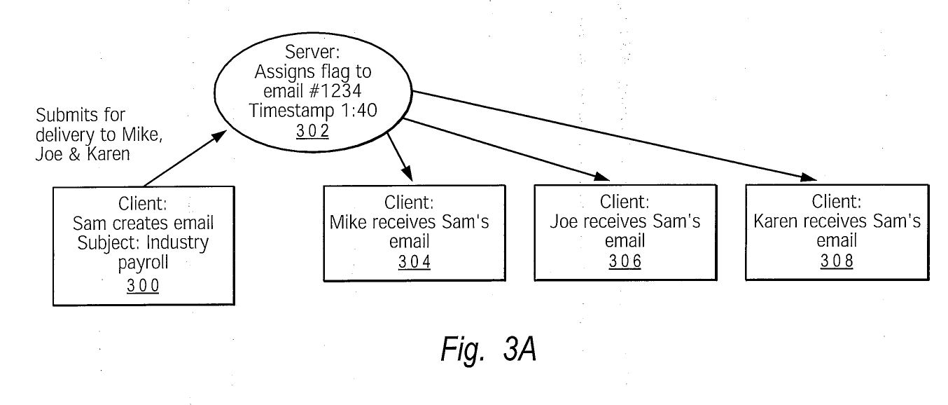

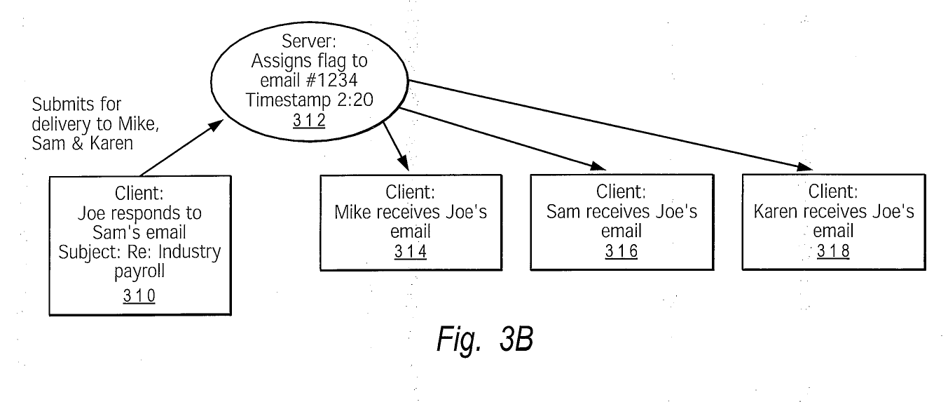

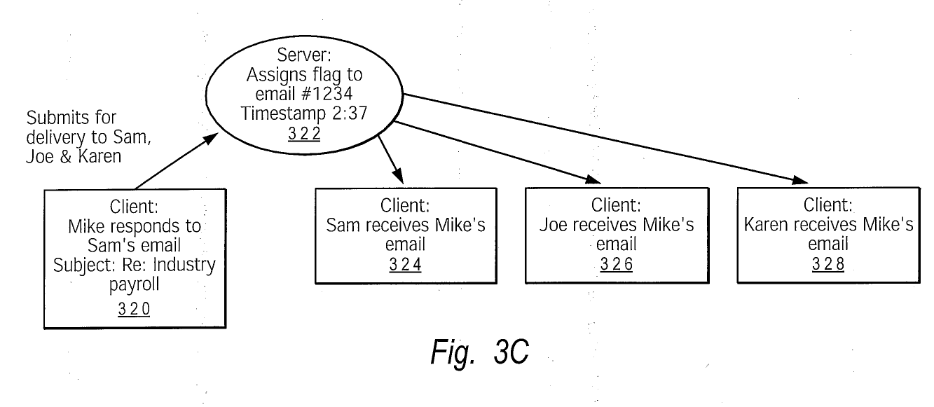

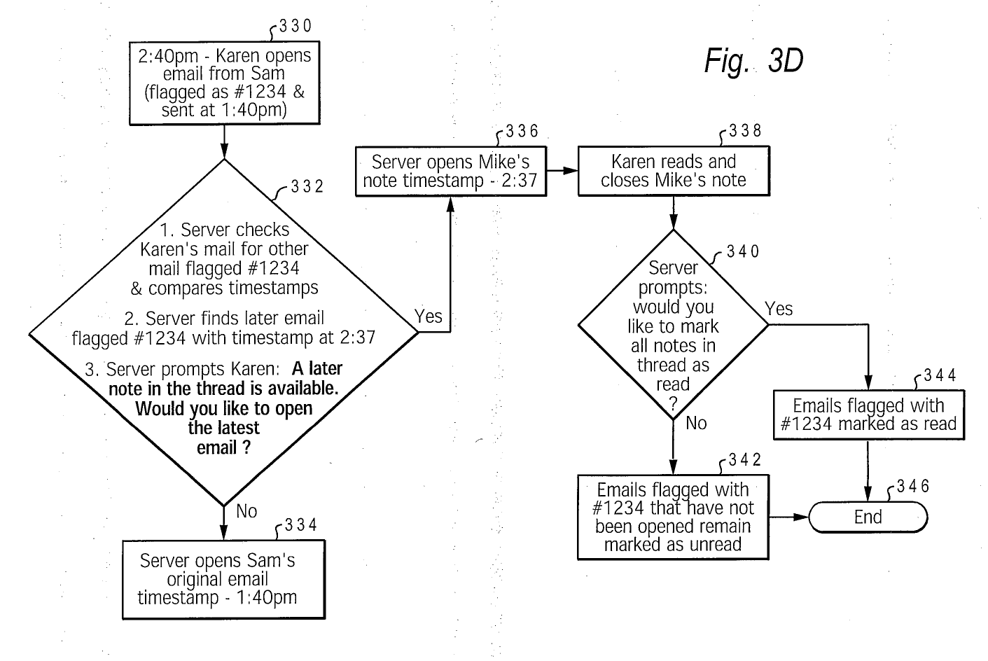

As illustrated, operating system 202 also includes kernel 206, which includes lower levels of functionality for operating system 202 and application programs 208, including memory management, process and task management, disk management, and mouse and keyboard management. Application programs 208 can include a browser, utilized for access to Internet 56, world processors, spreadsheets, and other application programs Also, as depicted in FIG. 2, e-mail client 210 enables a client 54 to compose, send, and receive e-mail messages from other clients. E-mail client 210 will be described herein in more detail in conjunction with FIGS. 3A-3D.

FIGS. 3A-3D illustrate an exemplary method for implementing latest edition notification for messages on a data processing system. While the following discussion includes the operations between four clients similar to clients 54a-54n in regards to one e-mail exchange, those with skill in the art will appreciate that the present invention includes any number of clients with any number of e-mail exchanges.

Referring now to FIG. 3A, Sam, Mike, Joe, and Karen represent users that are utilizing computer systems that may be implemented by clients 54a-54n. For ease of discussion, the computer systems are referred to by the user's names. As illustrated in block 300, Sam creates a first e-mail message with a subject heading of “Industry payroll” and submits the first e-mail message to server 52 for delivery to Mike, Joe, and Karen. Upon receipt of the first e-mail message, server 52 assigns a flag and time stamp (1:40 PM) to the first e-mail message, as depicted in block 302. Later, the e-mail clients of Mike, Joe, and Karen receive the first e-mail message, as shown in blocks 304, 306, and 308.

Referring now to FIG. 3B, Joe responds to the first e-mail message with a second e-mail message, as illustrated in block 310. The second e-mail message includes a subject heading of “Re: Industry payroll”. Upon receipt of the second e-mail message, server 52 assigns a flag and time stamp (2:20 PM) to the second e-mail message, as shown in step 312. Later, the e-mail clients of Mike, Sam, and Karen receive the second e-mail message, as depicted in blocks, 314, 316, and 318.

With reference to FIG. 3C, Mike responds to the first e-mail with a third e-mail message, as depicted in block 320. The third e-mail message also includes a subject heading of “Re: Industry payroll”. Upon receipt of the third e-mail message, server 52 assigns a flag and time stamp (2:37 PM) to the third e-mail message, as illustrated in block 322. Later, the e-mail clients of Sam, Joe, and Karen receive the third e-mail message, as shown in blocks 324, 326, and 328.

Referring now to FIG. 3D, Karen (at 2:40 PM) opens the first e-mail message sent by Sam, as illustrated by block 330. The process continues to block 332, which illustrates server 52 checking Karen's other e-mail messages for other message with the same message flag as the first e-mail message from Sam. Server 52 finds a later e-mail message, in this case, a third e-mail message with the same flag and a time stamp of 2:37 PM. Server 52 prompts Karen with “A later note in this thread is available. Would you like to open the latest e-mail?” If Karen's e-mail client determines that Karen does not wish to open the latest e-mail message in the thread, the process continues to block 334, which depicts server 52 opening Sam's original (first) e-mail message with a time stamp of 1:40 PM.

If Karen's e-mail client determines that Karen wishes to open the latest e-mail message in the thread, the process continues to block 336, which shows server 52 opening Mike's e-mail (third e-mail message) with the time stamp of 2:37 PM. The process proceeds to block 338, which illustrates Karen's e-mail client receiving a command to close the third e-mail message. The process continues to block 340, which illustrates server 52 determining if all notes in the thread should be marked as “read”. If server 52 determines the all notes in the thread should be marked as “read”, the process continues to block 344, which depicts server 52 marking all e-mails with the same flag as the first and third e-mail messages that have not been opened to be marked as read. The process then ends, as illustrated in block 346.

If server 52 determines the all notes in the thread should not be marked as “read”, the process continues to block 342, which depicts server 52 marking all e-mails with the same flag as the first and third e-mail messages that have not been opened to remain marked as “unread”. The process then ends, as shown in block 346.

As discussed, the present invention includes a computer-implementable method, system, and computer-readable medium for implementing latest edition notification for messages on a data processing system. An e-mail client receives from a server a first message in a conversation thread, wherein the conversation thread includes a collection of messages. In response to receiving a command from a user to open the first message, the server determines if the conversation thread includes a second message that was created after the first message. In response to determining the conversation thread includes the second message, the server opens the second message instead of the first message.

It should be understood that at least some aspects of the present invention may alternatively be implemented in a computer-usable medium that contains a program product. Programs defining functions in the present invention can be delivered to a data storage system or a computer system via a variety of signal-bearing media, which include, without limitation, non-writable storage media (e.g., CD-ROM), writeable storage media (e.g., hard disk drive, read/write CD-ROM, optical media), system memory, such as, but not limited to Random Access Memory (RAM), and communication media, such as computer and telephone networks including Ethernet, the Internet, wireless networks, and like network systems. It should be understood, therefore, that such signal-bearing media when carrying or encoding computer-readable instructions that direct method functions in the present invention represent alternative embodiments of the present invention. Further, it is understood that the present invention may be implemented by a system having means in the form of hardware, software, or a combination of software and hardware as described herein or their equivalent.

While the present invention has been particularly shown and described with reference to a preferred embodiment, it will be understood by those skilled in the art that various changes in form and detail may be made therein without departing from the spirit and scope of the invention.

What is claimed is:

1. A computer-implementable method for latest edition notification for messages, said method comprising:
receiving a first message in a conversation thread, wherein said conversation thread includes a plurality of messages;
in response to receiving a command from a user to open said first message, determining if said conversation thread includes a second message that was created after said first message; and
in response to determining said conversation thread includes said second message, openinig said second message instead of said first message.

2. The computer-implementable method according to claim 1, further comprising:
notifying said user of said second message; and
enabling said user to open said second message instead of said first message.

3. The computer-implementable method according to claim 1, further comprising:
notifying said user of said second message; and
opening said first message, if said user elects to open said first message.

4. The computer-implementable method according to claim 1, further comprising:
in response to determining all messages in said conversation thread should be marked as “read”, marking all messages in said conversation thread as “read”.

5. The computer-implementable method according to claim 1, further comprising:
in response to determining all messages in said conversation thread should be marked as “unread”, marking all messages in said conversation thread as “unread”.

6. A system for latest edition notification for messages, said system comprising:
a processor;
a data bus coupled to said processor;
a computer-usable medium embodying computer program code, said computer-usable medium being coupled to said data bus, said computer program code comprising instructions executable by said processor and configured for:
receiving a first message in a conversation thread, wherein said conversation thread includes a plurality of messages;
in response to receiving a command from a user to open said first message, determining if said conversation thread includes a second message that was created after said first message; and
in response to determining said conversation thread includes said second message, opening said second message instead of said first message.

7. The system according to claim 6, wherein said instructions are further configured for:
notifying said user of said second message; and
enabling said user to open said second message instead of said first message.

8. The system according to claim 6, wherein said instructions are further configured for:
notifying said user of said second message; and
opening said first message, if said user elects to open said first message.

9. The system according to claim 6, wherein said instructions are further configured for:
in response to determining all messages in said conversation thread should be marked as “read”, marking all messages in said conversation thread as “read”.

10. The system according to claim 6, wherein said instructions are further configured for:
in response to determining all messages in said conversation thread should be marked as “unread”, marking all messages in said conversation thread as “unread”.

11. A computer-usable medium embodying computer program code, said computer program code comprising computer-executable instructions configured for:
receiving a first message in a conversation thread, wherein said conversation thread includes a plurality of messages;
in response to receiving a command from a user to open said first message, determining if said conversation thread includes a second message that was created after said first message; and
in response to determining said conversation thread includes said second message, opening said second message instead of said first message.

12. The computer-usable medium according to claim 11, wherein said embodied computer-program code further comprises computer-executable instructions configured for:
notifying said user of said second message; and
enabling said user to open said second message instead of said first message.

13. The computer-usable medium according to claim 11, wherein said embodied computer-program code further comprises computer-executable instructions configured for:
notifying said user of said second message; and
opening said first message, if said user elects to open said first message.

14. The computer-usable medium according to claim 11, wherein said embodied computer-program code farther comprises computer-executable instructions configured for:
in response to determining all messages in said conversation thread should be marked as “read”, marking all messages in said conversation thread as “read”.

15. The computer-usable medium according to claim 11, wherein said embodied computer-program code further comprises computer-executable instructions configured for:
in response to determining all messages in said conversation thread should be marked as “unread”, marking all messages in said conversation thread as “unread”.
